(19) United States
(12) Patent Application Publication
(10) Pub. No.: US 2008/0236847 A1
(43) Pub. Date: Oct. 2, 2008

(54) Waste water containment, filtration, and transportation system and method

(76) Inventors: Robert M. Sanchez, La Habra, CA (US); Ignacio Sanchez, Diamond Bar, CA (US)

Correspondence Address: AVERILL & VARN, 8244 PAINTER AVE., WHITTIER, CA, 90602, US

(21) Appl. No.: 11/732,206

(22) Filed: Apr. 2, 2007

(51) Int. Cl. A62C 35/68; A62C 39/00

(52) U.S. Cl. 169/37; 169/43

(57) ABSTRACT

A waste water containment, filtration, and transportation system captures polluted waste water from various waste water sources including fire sprinkler systems and fire hydrants. The system includes a sight tube which connects to a female swivel connection on, for example, a Fire Department Connection (FDC). A flexible hose connects the sight tube to a mobile holding tank. The sight tube allows the observation of a waste water flow from the fire sprinkler system or fire hydrant to ensure that a complete flushing has been accomplished. A rod attached to an end of the sight tube holds a clapper in the FDC open during testing. The waste water is held in the mobile holding tank for later disposal. The containment and transportation system allows compliance with NFPA Standards, California State Fire Marshal's “Title 19 Regulations, the Federal Clean Water laws, the Federal Coastal Zone laws, as well as local city ordinances.

### BACKGROUND OF THE INVENTION

The present invention relates to containment of stagnant, polluted, and/or contaminated liquids and in particular to containment, filtration, and discharge of the stagnant, polluted, and/or contaminated water released from sprinkler systems during periodic testing.

Although the water entering a sprinkler system is generally potable water, there are subsequent effects which may drastically reduce the quality of the water in such systems. This water often remains in the sprinkler system for one or more years becoming contaminated, stagnant, and stale, having a very foul odor. Black iron pipe is generally used since it is more economical than potable piping, but unfortunately black iron pipe is prone to rusting which contaminates water residing in the black iron pipe. Also, new black iron pipe has an oil coating to protect it from rusting between manufacture and installation. This oil coating also contaminates the water.

In addition to the effects of using black iron pipe, the water residing in fire sprinkler lines in most buildings is contaminated with pollutants including chemicals, toxins, and disease causing agents. Nitrates, poly-phosphates and other corrosive inhibitors, as well as fire suppressants and anti-freeze may be added to the sprinkler water system as well. Also, between sprinkler system flushes, the water residing in the pipes may accumulate iron, magnesium, lead, copper, nickel, and zinc. This water generally becomes toxic and contains living and dead bacteria and breakdown products from chlorination. This may result in a significant Biochemical Oxygen Demand (BOD) problem. The BOD is a measure of the amount of oxygen required for the biochemical degradation of organic material in a water sample.

Such sprinkler systems are common in both residential and commercial building. Because of the obvious safety issues with reliance on a sprinkler system, periodic testing of sprinkler systems is required by the National Fire Protection Association (NFPA) standards (NFPA13). Such tests generally include draining and flushing stagnant, polluted, and/or contaminated water from the sprinkler systems and generally results in the stagnant, polluted, and/or contaminated water run off into the storm drains. The sprinkler tests include a Quarterly Fire Sprinkler Test, a Quarterly Drain Test, a Yearly Flow Test, a 5-Year Fire Sprinkler Certification Test, and a Flush Test for all new fire sprinkler system installations.

The Quarterly Fire Sprinkler Test includes placing an intentionally broken sprinkler head at the end of a sprinkler pipe to simulate an actual fire sprinkler activation. Fire sprinklers are designed to include an inspector's test valve attached with one inch piping leading to the outside of the building. Once the inspector's test valve is opened, it detects the broken sprinkler head and simulates an actual fire sprinkler activation. The inspector attempts to confirm that the local bell for the building goes off and also that a monitoring company has received a signal indicating that the sprinkler system has been activated. Stagnant, polluted, and/or contaminated water is released during this test and generally runs off into storm drains leading to streams, lakes and beaches.

The Quarterly Drain Test is required by the NFPA and insurance companies and requires opening a drain valve at a sprinkler riser for a few seconds and then closing the drain valve quickly to see how quickly a pressure gauge returns to normal pressure. The Quarterly Drain Test assures that a main valve out in the street is open and has not been accidentally closed by a public works employee. Again, the stagnant, polluted, and/or contaminated water released during this test generally runs off into the storm drains leading to streams, lakes and beaches.

The Yearly Flow Test is required by the NFPA on public and on-site fire hydrants (hydrants on private properties). The hydrant's valve is exercised and flowed. A diffuser is connected to a 2½ inch outlet on the fire hydrant and a pilot tube is used to measure the flow in Gallons Per Minute (GPM) and residual pressure when the valve is fully open. Again, stagnant, polluted, and/or contaminated water is released during this test and generally runs off into the storm drains leading to streams, lakes and beaches.

The Five Year Sprinkler Certification Test is perhaps the most important of all the fire sprinkler tests because without this certification, occupancy of the building cannot be granted. A portion of the Five Year Sprinkler Test requires that a backflush test be performed. The backflush test requires that a check valve located by the Fire Department Connection (FDC) be reversed or blocked in the open position in order to perform the test. This procedure requires one to shut-off the main control valve and to remove (generally unbolt), reverse the check valve, the control valve is then opened allowing water to run freely out to the FDC outlets which is an FDC inlet during normal operation. Such backflush insures that the FDC is free and clear of any obstructions, debris or foreign objects. If an FDC is clogged by such debris, or even merely contains such debris, the debris may enter the sprinkler system and may cause damage to the fire sprinkler system and/or make the system inoperable or less effective. The FDC is normally located by the sidewalk a few feet from the storm drains. The Five Year Sprinkler Certification Test is usually witnessed by the Fire Department to confirm that the FDC is clear. When this test is performed, the stagnant, polluted, and/or contaminated water released during the test generally runs off into the storm drains leading to streams, lakes and beaches.

Another NFPA requirement is that all new fire sprinkler system installations must have a Flush Test performed. The fire sprinkler system receives water from a Water Department's main potable water system (or main) generally running under a street in front of the building containing the system. An underground utilities company is usually contracted to perform a Hot Tap into the main. This requires specialized equipment to cut into the main while it is still containing water under pressure and install a control valve. The underground contractor then runs underground piping to the property line. The fire sprinkler contractor takes over at the property line and continues the underground piping, installing a backflow preventor, an FDC, and a control valve. Prior to connecting into the sprinkler's riser, the Flush Test of the underground piping is required. This test is witnessed by the Fire Department. Often, the water in the underground piping is black, contains oil, metal shavings, debris, etc. This stagnant, polluted, and/or contaminated water generally is released into the storm drains leading to streams, lakes and beaches.

In addition to periodic testing, in the course of a tenant improvement project, the standard procedure for a Fire Sprinkler Contractor is to drain the sprinkler system. However, some trapped water remains in the lines and is later emptied into, for example, a 55 gallon drum with wheels. A serviceman dumps the water, which often includes stagnant, polluted, and/or contaminated water, to the curb which leads to the storm drains leading to streams, lakes and beaches.

The release of contaminated water into storm drains not only causes sickness, but sometimes even deaths in humans, animals and aquatic life. This water pollution problem, along with other industrial wastes, has contributed to rendering several recreational areas, streams, lakes and beaches completely contaminated and unsafe.

The “Federal Clean Water Act” requires that the fire sprinkler waste water flushed from a sprinkler system be directed to a sewer leading into a water treatment plant. Under no circumstances should fire sprinkler water containing high levels of pollutants be allowed to enter the storm drains. The illegal practice of allowing contaminated fire sprinkler water to enter the storm drains has been ongoing for decades, perhaps since fire sprinklers were first introduced to the public, in spite of stiff fines and penalties from the Water Districts. Because of the present difficulty in satisfying the Federal Clean Water Act, sprinkler system tests are still conducted which allow the polluted water to enter storm drains.

Although some municipalities have started requiring containment of this flushed polluted water when performing these tests, known apparatus and methods have failed. Some have suggested running hoses connected to the FDC directly to a sewer line. Unfortunately, the sewer lines are often blocks away from the FDC and this procedure would require traffic control since the sewer plates are located in the middle of the streets. Also, the fire inspectors would have to be present at the street sewer plate to witness the clear water indicating that the FDC has been flushed and cleared.

Another proposed method is to have a waste management disposal company collect the water and then transfer it to a water treatment plant. But to coordinate with a fire inspector and a waste management disposal company is problematic. Because of the fire department inspector's heavy workload, they are often late for these scheduled tests. The added cost to contract a waste management disposal company, and have them also wait for the inspector, would have to be passed on to the business owner and would be cost prohibitive.

### BRIEF SUMMARY OF THE INVENTION

The present invention addresses the above and other needs by providing a waste water containment and transportation system which captures polluted waste water from various waste water sources including fire sprinkler systems and fire hydrants. The system includes a sight tube which connects to a female swivel connection on, for example, a Fire Department Connection (FDC). A flexible hose connects the sight tube to a mobile holding tank. The sight tube allows the observation of a waste water flow from the fire sprinkler system or fire hydrant to ensure that a complete flushing has been accomplished. A rod attached to an end of the sight tube holds a clapper in the FDC open during testing. The waste water is held in the mobile holding tank for later disposal. The waste water may be filtered and then released into storm drains, or the unfiltered waste water may be released into a sewer. The containment and transportation system allows compliance with NFPA Standards, California State Fire Marshal's “Title 19 Regulations, the Federal Clean Water laws, the Federal Coastal Zone laws, as well as local city ordinances.

In accordance with one aspect of the invention, there is provided a feasible and cost effective system and method for containing, filtering, and transporting polluted waste water flushed from sprinkler systems. The water containment and transportation system comprises a durable plastic water tank holding approximately 300 gallons or more, which tank is mountable onto a trailer or directly onto a truck. A non-kink hose is connected to the tank by a quick release coupling to allow a user to attach the hose directly to the tank. An opposite end of the hose is coupled to a hose end of a clear sight tube by a second quick release coupling, and a sprinkler system end of the clear sight tube is attached to a Fire Department Connection (FDC) of the sprinkler system. A rod protrudes from the sprinkler system end of the clear sight tube connector fitting and holds a clapper in the FDC open during the backflush test. The rod is preferably a ⅜ inch welded rod. The clear sight tube allows a fire department inspector to visually observe a waste water flow through the sight tube change from dirty to clean as the flushing of the fire sprinkler system is performed. The plastic containment tank stores the waste water flushed from the sprinkler system during the test. Once the test is complete, the user transports the tank to the nearest sewer line, preferably at a side street, opens a sewer plate and attaches a pre-pipe line with quick connects directly to the bottom of the tank. The tank has a control valve at the base of the tank. The user opens the control valve and releases the contaminated water into the sewer line. The tank may also contain filters to filter the waste water before release. When sufficient filtering is performed, and proper permission obtained from local authorities, the filtered waste water may be released into storm drains. Different standard fittings would be used for different applications, for example, Quarterly and Drain Tests.

In accordance with another aspect of the invention, there is provided a waste water collection and transportation system including a mobile holding tank for transporting waste water, a sight tube for observing the clarity of a waste water flow, and a hose connecting the sight tube to the mobile holding tank. In a preferred embodiment the sight tube includes a first connection end configured to connect to a Fire Department Connection (FDC) and a rod extending six inches from a first connection end to hold a clapper valve in the FDC open.

In accordance with yet another aspect of the invention, there is provided a method for waste water collection and transportation. The method includes: connecting a sight tube to a Fire Department Connection (FDC); connecting a hose to the sight tube; connecting the hose to a water tank; releasing a flow of water from the FDC through the sight tube and hose to the tank; continuing the flow-of water until a clean flow is observed in the sight tube; disconnecting the hose from the tank; transporting the tank to a sewer connection; filtering the water; and emptying the filtered water into the sewer. In a preferred embodiment, connecting the sight tube to the FDC includes connecting a first end of the sight tube including a protruding rod to the FDC so that the rod holds open a flapper valve in the FDC.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 depicts a waste water containment and transportation system according to the present invention connected to a Fire Department Connection (FDC).

FIG. 2A is a side view of a sight tube according to the present invention.

FIG. 2B is a top view of the sight tube.

FIG. 2C is an end view of the sight tube.

FIG. 3A is a side view of a barbed fitting of the sight tube.

FIG. 3B is an end view of the barbed fitting of the sight tube.

FIG. 4A is a side view of a rod attached according to the present invention to the sight tube for holding a flapper valve open.

FIG. 4B is a top view of the rod.

FIG. 4C is a rod extension according to the present invention.

FIG. 5 is a cross-sectional view of the sight tube taken along line 5-5 of FIG. 3A.

FIG. 6 is a view of a tank according to the present invention.

FIG. 7 is a method according to the present invention for containing and transporting waste water.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

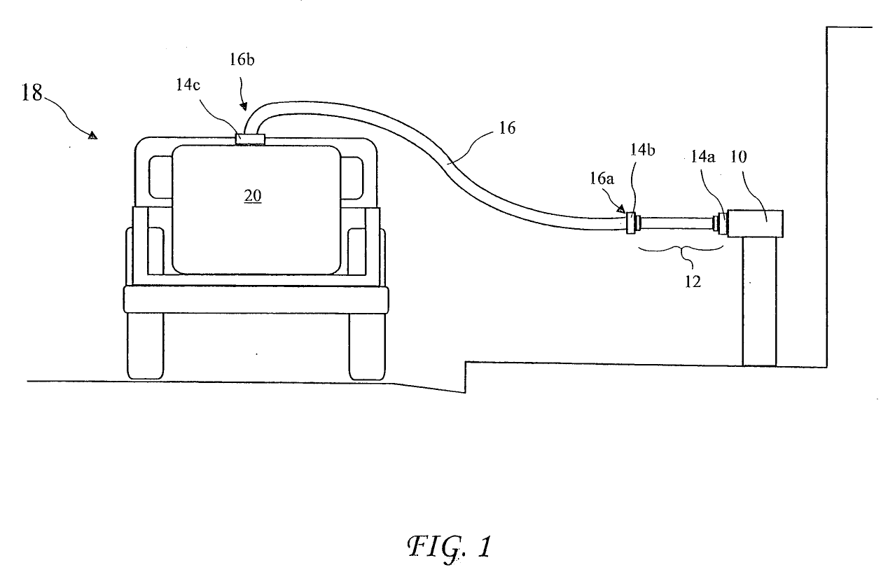

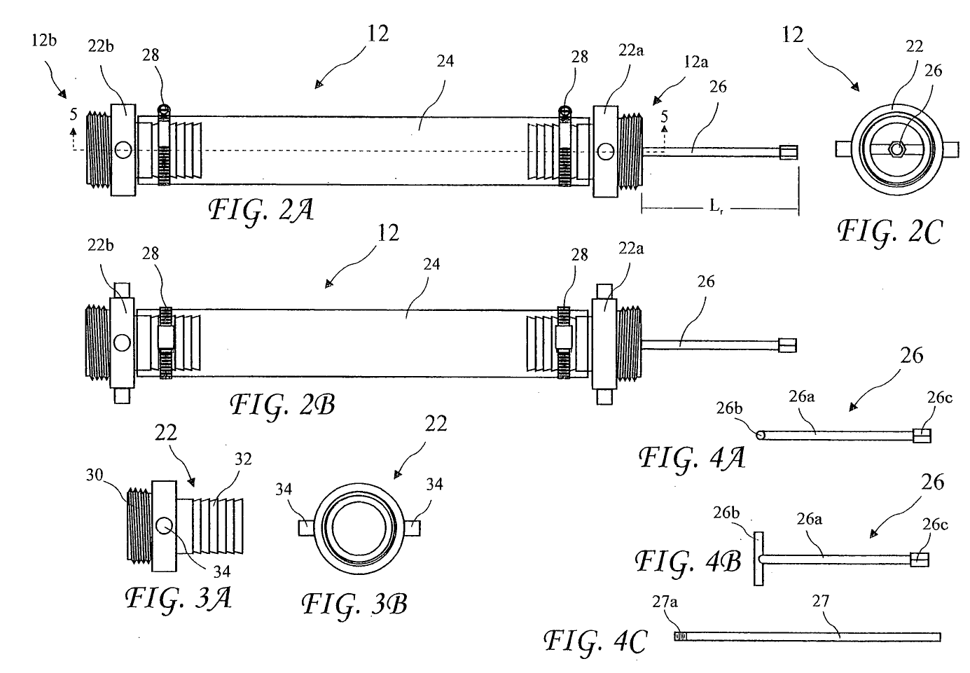

A waste water containment and transportation system according to the present invention is shown connected to a waste water source comprising a Fire Department Connection (FDC) 10 in FIG. 1. The waste water containment and transportation system includes a sight tube 12, a hose 16, and a tank 20. The tank 20 is preferably mounted to a truck 18 or to a trailer and is a mobile holding tank. The sight tube 12 is preferably attached between a first female swivel connection 14a attached to the FDC 10 and a second female swivel connection 14b attached to a sight tube end 16a of the hose 16. The hose 16 is connected to the tank 20 by a third female swivel fitting 14c at a tank end 16b of the hose 16. The hose 16 is preferably a two inch diameter non-kink hose and is preferably clear. A suitable material is Polyvinylchloride (PVC) and example of a suitable hose is Master-Flex® 101CL hose made by Gates Corporation in Denver, Colo. The waste water containment and transportation system may also be applied to containing and transporting waste water released from sources other than the FDC 10, and in those instances a sight tube with an appropriate connection may be used, or an adapter between the sight tube 12 and the waste water source may be used.

A side view of the sight tube 12 according to the present invention is shown in FIG. 2A, a top view of the sight tube 12 is shown in FIG. 2B, and an end view of the sight tube 12 is shown in FIG. 2C. The sight tube 12 is preferably a clear sight tube, or at least sufficiently clear to view a flow of waste water through the sight tube 12 well enough to determine when the flow has become clean or sufficiently clean to end a test. The sight tube 12 is preferably between approximately eight inches and approximately 24 inches long and more preferably approximately twelve inches long, and preferably has an inside diameter between approximately 2¼ inches and approximately 2¾ inches and more preferably has an inside diameter of approximately 2½ inches. Barbed male fittings 22a and 22b are attached to opposite ends of a length of tubing 24 to form the sight tube 12. An example of a suitable material for the tubing 24 is Poly Ethylene-Terephthalate Glycol (PETG) clear tubing made by Visipak in Arnold, Mo. The first fitting 22a connects to the first female swivel fitting 14a on the FDC 10 (see FIG. 1), and the second fitting 22b connects to the second swivel fitting 14b on the hose 16. Clamps 28 are tightened around the outside of the tubing 24 to cause the tubing 24 to grasp the fittings 22a and 22b. The clamps 28 are preferably hose clamps.

A rod 26 extends from a first sight tube end 12a of the sight tube 12. The rod 26 is approximately coaxial with the sight tube 12 and when the sight tube 12 is connected to the FDC 10, the rod 26 pushes against a one-way-valve (generally a clapper valve) inside the FDC 10 to hold the FDC 10 open to allow a flow of waste water to flow from the FDC 10 through the sight tube 12 and hose 16 into the tank 20. The rod 26 extends from the sight tube a length Lᵣ which is sufficiently long to hold the one-way valve open sufficiently to run tests, but not too long to prevent the sight tube 12 from being fully attached to the FDC 10. The length Lᵣ is preferably between approximately six inches and approximately sixteen inches, and is more preferably approximately six inches. The rod 26 is preferably made from approximately ⅜ inches diameter aluminum tubing. A second sight tube end 12b resides opposite the first sight tube end and is generally connected to the hose 16.

A side view of the barbed fitting 22a or 22b of the sight tube 12 is shown in FIG. 3A and an end view of the barbed fitting 22a or 22b is shown in FIG. 3B. The barbed fittings 22a or 22b include male threads 30, barbed portions 32, and tightening features 34. The threads 30 are preferably sized to connect to the female swivel fittings 14a and 14b and are more preferably threaded with a National Pipe Thread (NPT). The barbed portions 32 are approximately 3½ inches long. The features 34 are provided to aid in turning, or preventing turning of, the sight tube 12 when the sight tube 12 is connected to the FDC 10 or the hose 16. The features are preferably round cylindrical projections from opposite sides of the fittings 22a and 22b. An example of a suitable fitting 22a or 22b is a 2½ inch available from the J. C. Gadd Company in Denver, Colo.

A side view of the rod 26 according to the present invention is shown in FIG. 4A and a top view of the rod 26 is shown in FIG. 4B. The rod 26 comprises a longitudinal portion 26a which extends from the sight tube 12 into the FDC 10, and a lateral portion 26b attached to the longitudinal portion 26a and to an inside diameter of the fitting 22a. A threaded fitting 26c is attached to the end of the rod 26 to allow extensions to be screwed onto the rod 26 for applications requiring a longer rod length Lᵣ (for example, sixteen inches) for holding a one-way-valve open.

A rod extension 27 is shown in FIG. 4A. The rod extension 27 includes a threaded end 27a which cooperates with the threaded fitting 26c (see FIGS. 4A and 4B) to attach the rod extension 27 to the rod 26.

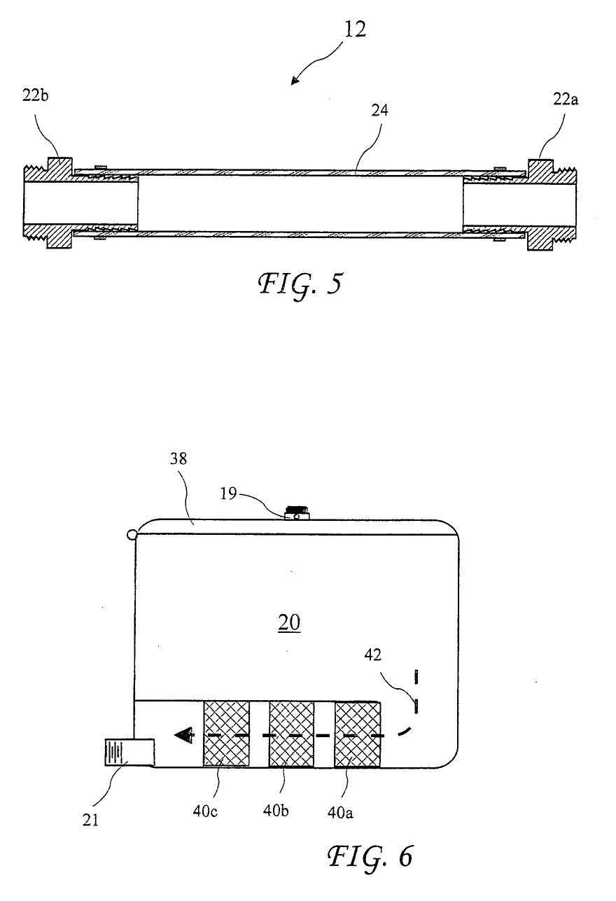

A cross-sectional view of the sight tube 12 taken along line 5-5 of FIG. 3A is shown in FIG. 5.

A view of the tank 10 according to the present invention is shown in FIG. 6. The tank 10 includes a threaded fitting 19 residing on a hinged top 38. The threaded fitting 19 cooperates with the female swivel fitting 14c on the tank end of the hose 16 to connect the hose 16 to the tank 20. Filters 40a, 40b, and 40c reside sequentially in the tank 20 to sequentially filter a flow 42 of the waste water before releasing the waste water through a fitting 21 for connecting to a pre-pipe line for draining filtered waste water contained in the tank 20 into a sewer system. The filters 40a-40c are preferably removable and replaceable by opening the hinged top 38, and the filters preferably include pollutant filters, oil filters, and the like and are preferably disposable filters.

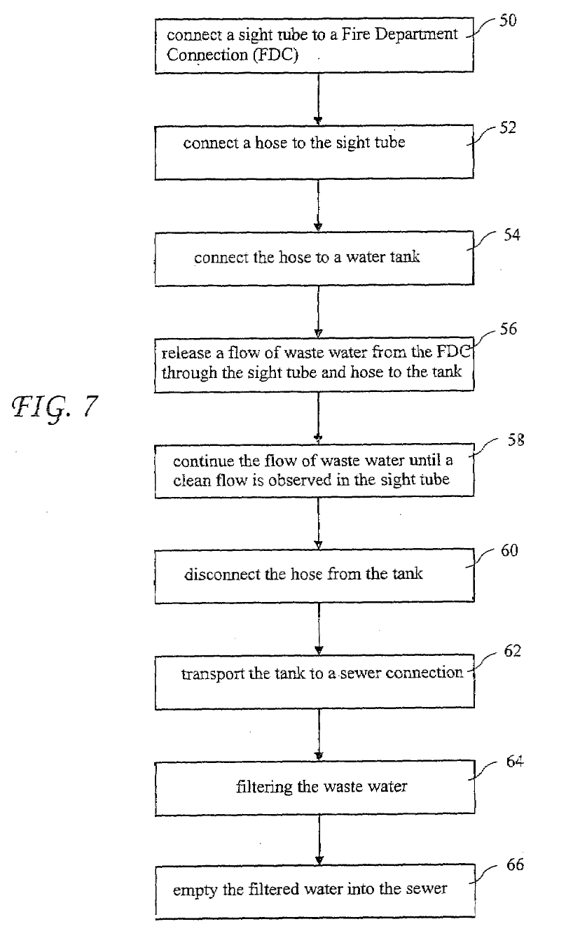

A method according to the present invention for containing and transporting waste water is described in FIG. 7. The method includes: connecting a sight tube to a waste water source, for example a Fire Department Connection (FDC), at step 50; connecting a hose to the sight tube at step 52; connecting the hose to a water tank at step 54; releasing a flow of waste water from the waste water source through the sight tube and hose to the tank at step 56; continuing the flow of waste water until a clean flow is observed in the sight tube at step 58; disconnecting the hose from the tank at step 60; transporting the tank to a sewer connection at step 62; filtering the waste water at step 62; and emptying the water into the sewer at step 64. In a preferred embodiment, the sight tube is connected to the FDC and the method further includes connecting a first end of the sight tube including a protruding rod to the FDC so that the rod holds open a flapper valve in the FDC.

While the invention herein disclosed has been described by means of specific embodiments and applications thereof, numerous modifications and variations could be made thereto by those skilled in the art without departing from the scope of the invention set forth in the claims.

I claim:

1. A waste water collection and transportation system comprising:
a holding tank for collecting waste water;
a sight tube for observing the clarity of a waste water flow;
a hose for carrying the waste water flow, the hose and the sight tube connectable in-series between a waste water source and the holding tank; and
fittings at one end of the in-series hose and sight tube configured to connection to the waste water source.

2. The waste water containment system of claim 1, wherein the mobile holding tank holds at least approximately 300 gallons of waste water.

3. The waste water containment system of claim 1, further including a rod extending from a first connection end of the in-series hose and the sight tube, the first connection end connectable to the waste water source, wherein the rod is configured to hold open a one-way-valve residing in the waste water source.

4. The waste water containment system of claim 3, wherein:
the first connection end is a first connection end of the sight tube; and
the rod extends coaxially from the first connection end a sufficient distance to hold the one-way-valve open when the first connection end is connected to the waste water source.

5. The waste water containment system of claim 3, wherein the waste water source is a Fire Department Connection (FDC) and the first connection is a male fitting configured to connect with a first female swivel fitting on the FDC.

6. The waste water containment system of claim 3, wherein the waste water source is a Fire Department Connection (FDC) and the rod extends approximately six inches from the first connection end to hold a clapper valve in the FDC open.

7. The waste water containment system of claim 1, wherein the sight tube comprises:
between approximately eight inches and 24 inches of approximately 2½ inches inside diameter clear tubing;
two male barbed ends, the barbs residing inside ends of the clear tubing; and
clamps on the exterior of the clear tubing residing over the barbed ends and clamping the tubing to hold the barbs in place.

8. The waste water containment system of claim 7, wherein the male barbed ends have 2½ inch National Standard Threads (NST) threads.

9. The waste water containment system of claim 8, wherein the hose includes a hose end with a second female swivel fitting for connecting to a second barbed end of the sight tube.

10. The system of claim 1, wherein the holding tank is a mobile holding tank residing on one of the group consisting of a truck and a trailer.

11. The system of claim 1, further including at least one filter residing in the holding tank for filtering waste water collected in the holding tank before the waste water is released from the tank.

12. The system of claim 11, wherein the at least one filter comprises a least two disposable filters residing sequentially in a flow of the waste water to an outlet of the tank.

13. A waste water collection and transportation system comprising:
a holding tank for holding waste water;
a sight tube having a first connection end configured to connect to a Fire Department Connection (FDC), the sight tube for observing the clarity of a waste water flow from the FDC;
a rod extending six inches from a first connection end to hold a clapper valve in the FDC open;
a hose for carrying the waste water flow from the sight tube to the mobile holding tank; and
fittings at one end of the in-series hose and sight tube configured to connect to the waste water source.

14. A method for waste water collection and transportation, the method comprising:
connecting a sight tube to a Fire Department Connection (FDC);
connecting a hose to the sight tube;
connecting the hose to a water tank;
releasing a flow of waste water from the FDC through the sight tube and hose to the tank;
continuing the flow of waste water until a clean flow is observed in the sight tube;
disconnecting the hose from the tank; and
emptying the waste water into a disposal site.

15. The method of claim 14, wherein connecting the sight tube to the FDC comprises connecting a first end of the sight tube including a protruding rod to the FDC so that the rod holds open a flapper valve in the FDC.

16. The method of claim 14, wherein emptying the waste water into the disposal site comprises emptying the waste water into a sewer connection.

17. The method of claim 16, further including transporting the waste water to the sewer connection before emptying the waste water into a sewer connection.

18. The method of claim 14, further including filtering the waste water before emptying the waste water into the disposal site.

19. The method of claim 18, wherein filtering the waste water before emptying the waste water into the disposal site comprises flowing the waste water through filters residing inside the tank before emptying the waste water into the disposal site.

20. The method of claim 18, wherein:
filtering the waste water before emptying the waste water into the disposal site comprises filtering the waste water sufficiently to allow the filtered waste to be released into a storm drain; and
emptying the waste water into the disposal site comprises releasing the filtered waste water into a storm drain.
